(19) United States
(12) Patent Application Publication
(10) Pub. No.: US 2006/0099498 A1
(43) Pub. Date: May 11, 2006

(54) Cylindrical chargeable battery module

(76) Inventor: Shih-Chi Chang, Tortola (VG)

Correspondence Address: DAVID E. DOUGHERTY;Dennison, Schultz, Dougherty & Macdonald, Suite 105, 1727 King Street, Alexandria, VA, 22314-2700, US

(21) Appl. No.: 10/981,781

(22) Filed: Nov. 5, 2004

(51) Int. Cl. H01M 6/42; H01M 2/00

(52) U.S. Cl. 429/149; 429/163

(57) ABSTRACT

A kind of cylindrical chargeable battery module includes an outer shell, a chain of batteries and a charge device. Wherein, the column-formed outer shell's column diameter is equal to that of a regularized cylinder battery; sides at both ends of the model group are anode and cathode link points; the distance between the link points of anode and cathode is equal to the length of certain number of regularized cylinder batteries in series. The chain of batteries, put inside the outer shell, is composed of several series-wound units of batteries in line, each of which functions the same as a certain regularized cylinder battery, and this chain of batteries can be charged in a same charge device, whose jack for charge is exposed to the annulus of the outer shell. All in all, this invention is about a combinatorial group with the same function as several regularized cylinder batteries in series, which can be used as a unit in the battery casket of instruments and then taken out for keeping, and can be charged simultaneously, avoiding the difficulty of using and charging conventional single-unit cylinder batteries simultaneously.

### BACKGROUND OF THE INVENTION

The present invention relates to a cylindrical chargeable battery module, more particularly to a combinatorial group with the same function of several regularized cylindrical batteries in series, which can be used as a unit and charged simultaneously, so as to be kept in best function and good charge condition.

Conventional regularized cylindrical batteries are having different sizes of D, C, AA, and AAA, and normally used in electric torches, dynamoelectric toys, portable audio sets, or instruments like carriable e-commodities. However, different sized cylindrical batteries have different lengths of column diameter and height. Take a size C battery (see FIG. 1) for example, its column diameter is about 25.23 mm and the distance between the anode and the cathode is about 49.30 mm (see FIG. 1A). The desire for consumers to use chargeable batteries like Ni-MH or Ni-CH, which are generally used in the current market, goes stronger and stronger for the sake of frugality and environmental protection. Furthermore, when using most of instruments, we must prepare two or more batteries. Take a large electric torch (see FIG. 1B) for instance, it must be installed 3 batteries in series when we use it, with the column diameter remaining unchanged at 25.23 mm, and the distance between the anode and the cathode increasing to 147.90 mm (49.30 mm×3). But, all conventional regularized cylindrical batteries are designed in single unit. When instruments needs two or more batteries, the user must prepare the same number of batteries better with same brand (same electric specification), then install one by one the batteries in the casket of the instruments. When recharging the batteries, it's better to charge them in the same time, so as to keep their charge volume in synchronous state, avoiding excessive or uneven electricity consuming resulted from non-synchronous use which would possibly shorten the life-span of the batteries. When there is a long time not using the instruments, it's generally suggested the batteries be taken out. But these batteries can easily disperse or blend together with some others, consequently not easy to keep together, resulting that they cannot be easily sorted out when being used the next time. It's better to charge the batteries in a charge device with several grooves, otherwise, they must be charged separately and consequently bringing the user trouble in the operation of charge. At last, larger-sized charge batteries like size D and C are not convenient to schlep because of its large casket for charge. We often need to prepare more conventional batteries for spare use when we are going outside, which will lead to problems like environmental pollution and resource wasting. It's known from what is mentioned above that it is indeed inconvenient to use conventional single-unit regularized cylinder batteries.

### SUMMARY OF THE INVENTION

The primary object of the invention is to provide a cylindrical chargeable battery module, which consists of an outer shell, a chain of batteries and a charge device. This outer shell is column-formed, with the length of the column diameter equal to that of conventional regularized cylindrical batteries. There is an anode link conductor on one side at the end of the shell, and a cathode on the other, and the distance between the anode and the cathode is designed at the same length of certain number of regularized cylindrical batteries in series. The chain of batteries is set inner the outer shell, and it is series-wound into a line by several units of battery, with the same function as the equivalent number of regularized cylindrical batteries. This chain is equipped with a charge device, with the jack for charge set in the annulus of the outer shell. As a result, this invention becomes a combinatorial group of several regularized cylindrical batteries in series, replacing the equivalent number of conventional single-unit cylindrical batteries, and installed as a unit and charged simultaneously, so as to be used conveniently.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a conventional size C battery.

FIG. 1A is the scale of the size C battery shown in FIG. 1.

FIG. 1B is the scale of three size C batteries (FIG. 1A) in series.

FIG. 2 is a perspective view of the structure of an embodiment of the invention.

FIG. 3 is a perspective view the separated structure of the embodiment shown in FIG. 2.

FIG. 4 is a cross-sectional view of the embodiment shown in FIG. 2.

FIG. 4A is the amplified view of the cathode end shown in FIG. 4.

FIG. 4B is the amplified view of the anode end shown in FIG. 4.

### DETAILED DESCRIPTION OF THE PREFERRED EMBODIMENT

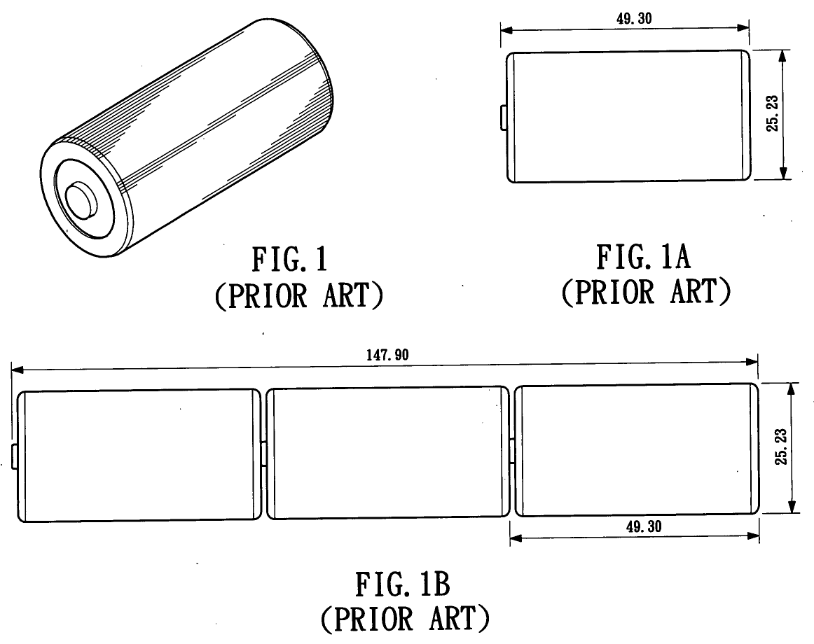

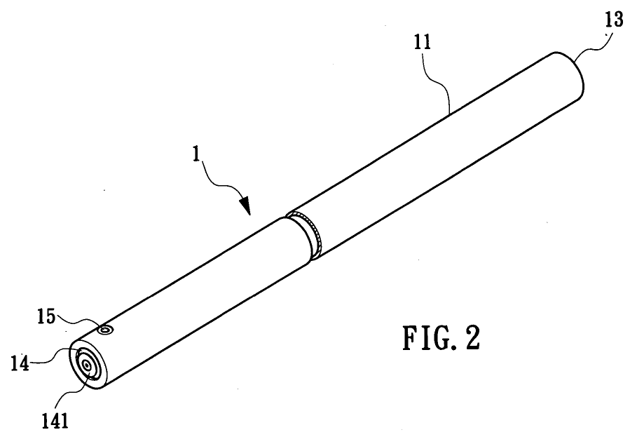

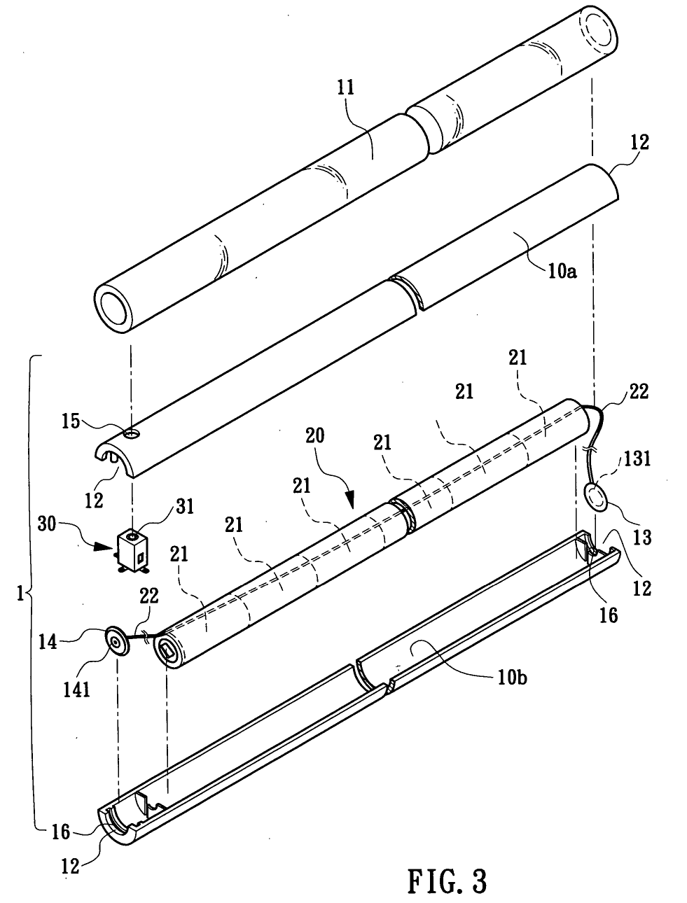

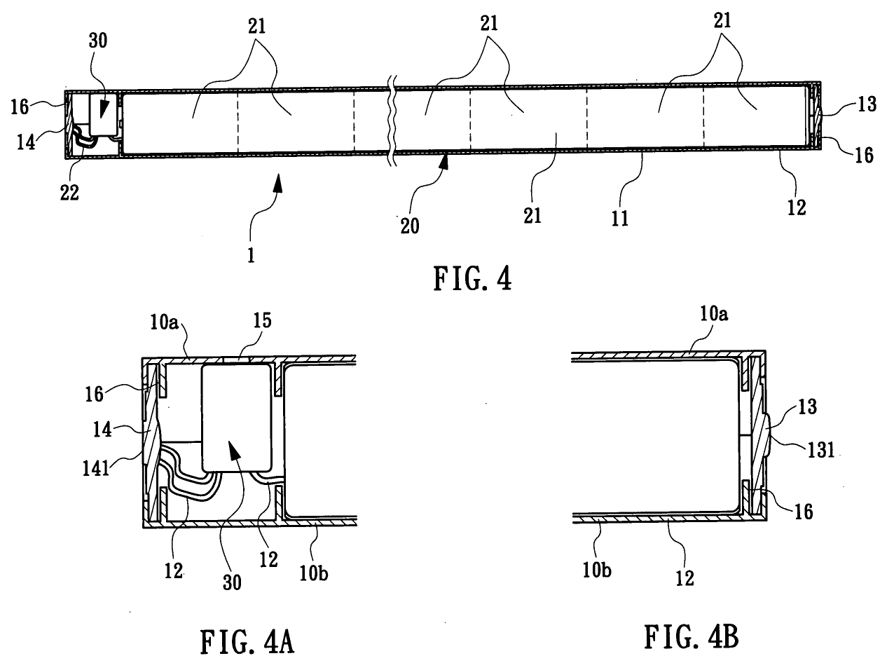

See FIGS. 2, 3, 4, 4A, 4B, this invention cylindrical chargeable battery module 1 is mainly composed of an outer shell 10, a chain of batteries 20 and a charge device 30, wherein, the shell is column-formed, set up simply by fastening two halves 10a and 10b together, and covered with plastic film 11. The covering of plastic film 111 can be processed by contracting film or surface stick, preventing the two semiconductors 10a and 10b from loosing with each other. And other designs like specification guide or advertising icons can be printed on the surface of the plastic film, so as to cover the fastening line between the two halves 10a and 10b and decorate the battery module. The column diameter of the outer shell 10 is set at the same length as one of regularized cylindrical batteries sized D, C, AA, and AAA. Take a size C battery for instance, the column diameter of the shell 10 is fixed at about 25.23 mm. There is a hole 12 at each end of the cross section of the shell 10. Inner one hole is an anode link conductor 13, and the other a cathode link conductor 14. The link points 131 and 141 of the anode link conductor 13 and the cathode link conductor 14 are exposed to the holes 12 in the cross section of the shell 10, and therefore form the anode and cathode link structure (FIG. 1) of a conventional regularized cylindrical battery. The distance between the link points of anode and cathode 131, 141 is exactly the length of certain number of regularized cylindrical batteries in series. Take a size C battery for instance, the distance between the link points of anode and cathode 131, 141 of the shell 10 can be fixed at multiple of 49.30 mm, including 49.30 mm×3, 49.30 mm×4, or 49.30 mm×5 (49.30 mm×N).

The chain of batteries 20, put inside the outer shell 10, is consisting of several series-wound battery units 21. Every unit is equal to a certain regularized cylindrical battery, which makes chain of batteries 20 function homologous as the equivalent number of same regularized cylindrical batteries. Say, if the distance between the link points of anode and cathode 131, 141 of the shell 10 is fixed at four times (192.20 mm) of the length (49.30 mm) of a size C battery, chain of batteries 20 will function the same as four size C batteries in series. The chain of batteries 20 is connected electrically with anode link conductor 13, cathode link conductor 14, and a charge device 30 by related leads, bringing itself into series state, and charge device 30 is therefore used to charge chain of batteries 20. The jack 31 for charge in charge device 30 is corresponding to the faucet 15 in the annulus of shell 10, so that a charge connector plug (not shown in the drawing) can plug from outside into the faucet 15, making it convenient for charging.

The components mentioned above, including chain of batteries 20, charge device 30, anode link conductor 13 and cathode link conductor 14, are firmly set inner the shell 10, wherein, anode link conductor 13 and cathode link conductor 14 are located by the symmetrical grooves 16 between the two halves 10a and 10b, or use insulating resin to fix the chain of batteries 20, charge device 30 and leads 22. The connecting relationship between charge device 30 and related leads 22 is about a conventional technology, therefore, whose inner formation or connecting state will not be explained here in detailed.

Based on the structures mentioned above, this invention, cylindrical chargeable battery module 1, sets up a combinatorial group with the same function as several regularized cylindrical chargeable batteries in series, which can be installed as a unit and charged simultaneously, avoiding the trouble of using conventional single-unit cylindrical batteries, and then used more conveniently.

What is claimed is:

1. A cylindrical chargeable battery module comprising a base, an outer shell, a chain of batteries and a charge device, wherein:
the outer shell, column-formed, is made by fastening two halves together, with its cylinder diameter fixed at the same length as one of regularized cylindrical batteries. There is a hole at each end of the cross section of the outer shell. Inner one hole is an anode link conductor, and the other a cathode link conductor. The link points of the two conductors are exposed to the two holes at the end of the cross section of the shell, which therefore forms the anode and cathode link points of the cylindrical chargeable battery module. The distance between the link points of anode and cathode multiples the length of a certain regularized cylindrical battery;
the chain of batteries, put inside the outer shell, is composed of several series-wound battery units in line. Every battery unit functions the same as a certain regularized cylindrical battery, which makes the chain of batteries function homologously as the equivalent number of same regularized cylindrical batteries in series. The chain of batteries is connected electrically with an anode link conductor, a cathode link conductor, and a charge device by related leads, bringing it into series state, and the charge device is therefore used for charging; and the charge device is set inner the outer shell, wherein, the jack for charge is corresponding to one faucet on the annulus of the outer shell, so that a charge connector plug can plug from outside into the faucet to charge the chain of batteries.

2. A cylindrical chargeable battery module as claimed in claim 1, wherein the outer of said shell can be covered with a plastic film.

3. A cylindrical chargeable battery module as claimed in claim 2, wherein the covering of said plastic film may be processed by contracting film or surface stick.

4. A cylindrical chargeable battery module as claimed in claim 2 and 3, wherein some designs for decoration may be printed on said plastic film.

5. A cylindrical chargeable battery module as claimed in claim 1, wherein said anode and cathode link conductors are located at ends of the cross section of said shell by the symmetrical grooves between said two halves.

6. A cylindrical chargeable battery module as claimed in claim 1, wherein said charge device is near the end of inner of said outer shell.

7. A cylindrical chargeable battery module as claimed in claim 1, wherein the column diameter of said outer shell is designed at the same diameter as one of regularized cylindrical batteries sized D, C, AA, and AAA.

8. A cylindrical chargeable battery module as claimed in claim 1, wherein the distance between said link points of anode and cathode on said shell multiples the length of certain number of regularized cylindrical batteries sized D, C, AA, and AAA.
